(19) United States
(12) Patent Application Publication
(10) Pub. No.: US 2026/0179502 A1
(43) Pub. Date: Jun. 25, 2026

(54) Adaptive Improvisation Learning Engine

(71) Applicant: Georgia State University Research Foundation, Inc., Atlanta, GA (US)

(72) Inventor: Martin Norgaard, Roswell, GA (US)

(21) Appl. No.: 19/125,389

(22) PCT Filed: Sep. 12, 2023
(86) PCT No.: PCT/US2023/073952

§ 371 Date: Apr. 29, 2025

Related U.S. Application Data
(60) Provisional application No. 63/421,869, filed on Nov. 2, 2022.

(51) Int. Cl. G09B 7/02

(52) U.S. Cl. CPC G09B 7/02

(57) ABSTRACT

A method and system are described for providing improvements to a user's ability to improvise a lick on a musical instrument. A user's played lick is detected and compared with a lick from a pattern repository of licks. Depending on how well the user-played lick matches the lick from the pattern repository, a new lick from the pattern repository is played to the user. The difficulty level of the new lick depends on how well the user's played lick matches the lick from the pattern repository. The difficulty level comprises one of several measures of difficulty including extrinsic difficulty and intrinsic difficulty.

### CROSS-REFERENCE TO RELATED PATENT APPLICATION

The present patent application claims priority to U.S. Provisional Patent Application No. 63/421,869, filed Nov. 2, 2022, and entitled “Adaptive Improvisation Learning Engine”, the disclosure of which is incorporated herein by reference thereto.

### BACKGROUND OF THE INVENTION

This disclosure relates to systems and methods for teaching a student to improvise music more effectively.

The interaction between a music teacher and a learner ideally requires in-person individual instruction which is expensive and out of reach for many students. It is difficult to find a teacher to help a student improve the student's ability to improvise licks. By its very nature, it is difficult to improvise without additional music playing. Currently available music learning software (e.g. Smart Music and Yousician) only teaches composed music, not improvisation. These existing solutions allow students to play composed music and, through pitch identification and automated evaluation, they provide feedback on a number of pitch and rhythm errors. However, these software solutions are unable to teach, evaluate, and improve student improvisations.

Accordingly, a need arises for techniques that provide a student the ability to improve the student's skill with improvisation without a physical teacher present.

### SUMMARY OF THE INVENTION

Aspects of the disclosure relate to systems and methods for matching a student played lick with a lick from an existing database, and providing the student with a lick of comparable or greater difficulty to play in response.

The present disclosure relates to systems and methods of teaching a user to improve improvisational musical skill. The method detects, through an audio detecting device, a lick played by a user (“user-played lick”), and converts the user-played lick into an electrical signal. The electrical signal is matched by a pattern recognition module to a lick selected from a pattern repository comprising a database of licks. A metric is calculated associated with how well the user-played lick matches the lick selected from the pattern repository. In an example, the selected lick can be chosen based on being the closest match to the user-played lick. The matching metric can be conveyed to the user. For instance, the system can display the metric to the user. In an example, the system can speak aloud an encouraging phrase to the user, dependent upon the matching metric. In an example, when the metric is less than or equal to a threshold value, the system can play the selected lick to the user. In an example, when the metric is greater than a threshold value, the system can play a second lick selected from the pattern repository.

When the system plays a lick for the user, that lick can be called the “system-played lick” (e.g. the first selected lick or the second selected lick). These system-played licks can be assigned a difficulty level or measure. In an example, the second selected lick can be selected depending on the matching metric and on the difficulty level of the first selected lick. For instance, if the metric is less than or equal to a threshold value, then the second selected lick can have a difficulty level equal to or less than the difficulty level of the first selected lick. In an example, the system could play the selected lick again, and continue to play the same lick until the matching metric exceeds a threshold value or until the lick has been played a certain number of times. If the metric exceeds a threshold value, then the second selected lick can have a difficulty level greater than the difficulty level of the user-played lick or greater than the difficulty level of the previous system-played lick. If the user plays a lick a number of times and the metric for each attempt at playing the lick exceeds a threshold value, then a new lick with a greater difficulty level can be selected and played to the user as the next lick for the user to play. As used in this context, “second lick” is meant to include a system-selected and played lick that is responsive to a user-played lick. The method can provide to the user a recommendation for how to improve the user's played lick. In an embodiment, the system may continue to supply licks so long as the user continues to play licks which are well-matched.

The method can further comprise generating at an audio generating device a new lick, from the pattern repository, with a difficulty level of the new lick determined by the calculated metric. The difficulty level can comprise an extrinsic difficulty level, an intrinsic difficulty level or combinations of extrinsic and intrinsic difficulty levels. The difficulty level can comprise at least one of a negative logarithm of an occurrence probability of an n-gram relative to all n-grams of the same length in the pattern repository, a mean of a plurality of absolute interval values, a maximum of the plurality of absolute interval values, a range of the plurality of interval values, a mean number of different intervals, a mean number of different pitches, a mean number of direction changes or a mean length of runs in an interval direction. The difficulty level can further comprise a combined sum of a z-transform of the mean of the plurality of absolute interval values, the mean number of different intervals, the mean number of different pitches, the mean number of direction changes and the mean length of runs in an interval direction.

The disclosure further relates to a system comprising an audio detecting device, an audio generating device, a pattern repository, and a computer. The system can perform the method, as described above and elsewhere herein.

### BRIEF DESCRIPTION OF THE DRAWINGS

So that the manner in which the above recited features of the present invention can be understood in detail, a more particular description of the invention, briefly summarized above, can be had by reference to embodiments, some of which are illustrated in the appended drawings. It is to be noted, however, that the appended drawings illustrate only typical embodiments of this invention and the invention can admit to other equally effective embodiments.

FIG. 1 illustrates a flow chart of an embodiment of the invention.

FIG. 2 illustrates a computing device.

Other features of the present embodiments will be apparent from the Detailed Description that follows.

### DETAILED DESCRIPTION

In the following detailed description of the preferred embodiments, reference is made to the accompanying drawings, which form a part hereof, and within which are shown by way of illustration specific embodiments by which the invention can be practiced. It is to be understood that other embodiments can be utilized and structural changes can be made without departing from the scope of the invention. Electrical, mechanical, logical, and structural changes can be made to the embodiments without departing from the spirit and scope of the present teachings. The following detailed description is therefore not to be taken in a limiting sense, and the scope of the present disclosure is defined by the appended claims and their equivalents.

The present disclosure relates to a real-time feedback-based music improvisation training method and system.

Musical improvisation is often taught through the trading of musical figures called “licks”, between teacher and learner. In terms of teaching, the teacher can play a lick, and the student/learner will imitate. To learn to improvise, the teacher will often ask the learner to “answer” the lick by playing something different that is complimentary to the teacher's just played example. Artist level teachers can present licks in logical learning sequences that guide learners through progressively more difficult material. It is believed that no automated version of this human learning strategy currently exists.

Furthermore, this human strategy is severely limited. A human teacher will naturally have some level of subjectivity in their analysis of the student's performance, and the teacher's ability to present licks of known and progressive (or regressive, if needed) difficulty in a logical sequence will be naturally confined by the teacher's knowledge of the universe of licks themselves. It is highly unlikely, if not impossible, for a teacher to know, for example, all of the licks one would find available in an entire music repository, let alone be able to instantly assess the difficulty of the repository's licks, choose the best ones to play, and then actually perform them for the student responsively and in real-time. And similarly, it is believed that no automated system currently exists to perform these functions either—i.e. a system that improves the human learning strategy by being more objective and more comprehensive than a human teacher can be in the ability to responsively pull new licks from the entire pattern repository based on an assessment of the student performance and difficulty level of potential responsive licks.

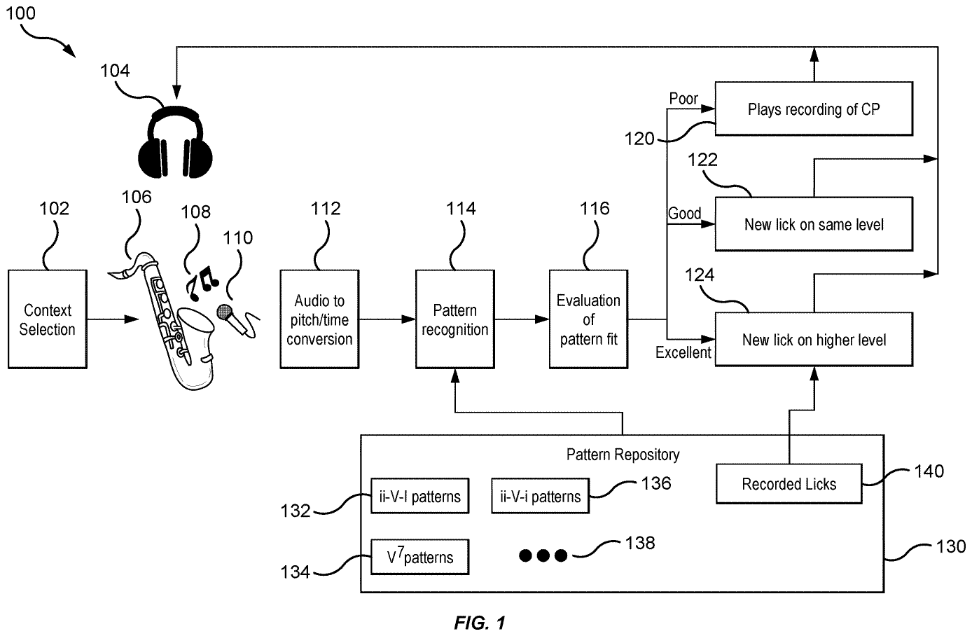

This disclosure describes a pattern recognition-based music learning and improvisation algorithm and system that uses pitch and timing information of licks to build an Adaptive Improvisation Learning Engine (AILE). The system analyzes short licks played by a student and selects a comparable reference lick in a database of expert licks or in a known collection of common patterns in the chosen style and calculates a metric of the quality of the lick played by the student by comparison to the reference lick. The selected expert lick can be stylistically appropriate, executed with good timing and articulation. If the calculated metric is at or below a certain threshold, the system then plays a recording of the expert lick for the student (e.g. “Poor” branch in FIG. 1). If the student responds by playing a version of the selected system-played lick which shows an improvement over the previous student-played lick, then the application can present a new lick of similar difficulty or a slightly more difficult lick for the student to imitate, leading the student to improve (e.g. “Good” in FIG. 1). If the student cannot follow this learning sequence, the application will adapt and keep playing the same lick or new licks of a similar difficulty level to which the student can respond or which the student can imitate. Furthermore, if the student plays a series of licks with good or improved timing and articulation, then the system can gradually increase the difficulty of the licks played for the user (e.g. “Excellent” in FIG. 1).

Part of such a system is a means for evaluating the difficulty level of the music. With pieces of composed music, a difficulty rating mechanism can be used, but with improvisations, it is more challenging to provide an immediate difficulty level. An advantage of this system is that it assesses the difficulty level of the music. Difficulty levels or difficulty measures, as described herein, can be dependent on the instrument. For example, chromatic passages are easy to play on a saxophone but not on a violin. Therefore, licks with chromatics can be categorized differently depending on the context.

In some instances, students can choose to play one instrument, with the system set to a different instrument for various purposes. For example, students who play the violin may want to trade fourths using the system set to “saxophone” specifically to learn jazz chromatics. A learning session can proceed in this fashion, or it can proceed in the more traditional fashion of the lick played on the same instrument, as the student desires. In an embodiment, the system can present to the user with an example prompt such as, “If you play a different instrument than the one selected, you may find some licks more difficult.” The system can also automatically detect which instrument the student is playing, and propose alternative instruments for performing the teaching lick. Alternatively, the system can adjust the difficulty level according to specific features of the played instrument.

An embodiment of the present disclosure is depicted in FIG. 1. The system 100 includes various steps and sub-systems. A user can select a harmonic context 102, for instance, a genre of music such as jazz, blues, pop, bluegrass, etc. The user can listen on a sound system 104 (e.g. headphones, stereo, etc.) and can play music 108 on the instrument 106. The music 108 played on the instrument 106 can be detected by a microphone 110, or other audio sensor. The system can be configured to subtract out background noise (e.g. lawnmower, traffic noise, etc.). The system can convert the input audio stream into an electronic signal and detect the pitch/time at 112. Pattern recognition algorithms 114 can work to find the best fit between a played pattern (PP) the pattern played by the user—and the pattern in a known collection of common patterns (CP) in the style/context selected. Various pattern recognition algorithms are known to those skilled in the art of signal processing or skilled in the musical arts. The difference between the timing and pitch of the student-played lick (PP) and the lick in the repository (CP) can be determined by the pattern recognition algorithm(s). The evaluation engine 116 can output a metric related to the quality of the student's playing of the music—e.g., the aforementioned difference between the PP pitch and timing and the CP pitch and timing. In an example, if the PP pitch and timing are inconsistent, or do not well fit the CP pitch and timing, then the metric can be “poor” or the metric can be assigned below a threshold value. In such a case (poor evaluation/fit), 120, the system can play for the student through the sound system 104 a high-quality audio version of the lick they had been trying to play. If the metric is, for instance, “good”, or at or above a threshold value, because the student timing and pitch of the PP corresponds well with the CP and fits the currently selected context, then a new lick can be played through the sound system 104, but the new lick can be at the same difficulty level as the original lick. In an embodiment, based on the evaluation of the matching the PP with the CP, the system may play a recording of the expert lick at 120 (fit is “Poor”) for the student to respond to. In another embodiment, the system may play a new lick at approximately the same level of difficulty at 122 (fit is “Good”). In an embodiment, the system may play a new lick at a higher level of difficulty at 124 (fit is “Excellent”). In an embodiment, the system may determine the next lick to play based on the matching metric (between the user-played lick and the system-played lick or between the user-played lick and a lick stored in the pattern repository) and also based on the difficulty levels of the licks.

In an example, if the metric is within a tolerance near to the threshold value, then the system can select from the pattern repository a new lick with a similar difficulty level as the previously selected lick. In an example, licks can have a comparable or similar difficulty level if their assigned difficulty levels are equal to each other within a tolerance. For example, if the difficulty level is a scale running from 0 to 100, an example tolerance may be +/−5. In this example, a lick with a difficulty level of, say, 50 could be followed by a lick with a difficulty level in the range 45−55=50±5. Other values of tolerance may be used as well, and the tolerance values can depend on the type of difficulty measures used. The tolerance and the initial difficulty level can also be selected by the user. In the example shown in FIG. 1 of a good evaluation or good fit 122, the student and the system trade different licks with each other with each traded lick having a difficulty level comparable to the other licks. In an example, if the student consistently (e.g. 5 times) plays the lick at the “good” level, then the student can be given the “excellent” metric at 124. For instance, if the student plays the lick a certain number of times in a row, and the matching metric between the user-played lick and the selected lick meets or exceeds a certain threshold value, then the system can select a new lick at a level of greater difficulty for the student. In another embodiment, if the matching metric between the user-played lick and the selected lick exceeds a threshold, then the system can directly play a new lick which is more difficult than the lick just played by the student. In such an instance (excellent fit after a first attempt), the system can play a new lick which is more difficult than the originally or previously presented lick. In another example, the fit metric can comprise a number, such as on a 0-100 scale, with 0 being the poorest fit and 100 being the best fit. In yet another example, the metric can be determined based on the fit and on the number of times the user has played the lick.

The metric can comprise a measurement of the difference between the pitch and timing values of the student lick (PP) and the target lick from the repository (CP). This metric could, for example, be calculated using the taxicab norm distance between the two licks using one or more of the following measures in any combination: distribution of pitch classes, distribution of pitch class dyads, distribution of intervals, distribution of interval dyads, melodic contour, distribution of note durations, distribution of note duration dyads. Instead of the taxicab norm, other distance metrics could be used including, for example, the Euclidean distance measure, an inverse of cosine of the angle between vectors, or any other distance measure, or a combination of any of these distance measures. In the example of the cosine of the angle between vectors, the student-played lick and the selected lick from the repository would first be vectorized before the distance measure can be calculated. In these exemplary calculations the order of played pitches in the two licks does not need to be considered. Therefore, the system can also compare smaller subsections of the two licks separately using distance measures. This calculation would result in a combined metric in which the order of pitches would affect the value of the metric.

The system 100 can make use of a pattern repository 130. The known collected patterns can come from, for instance, a public database 130 of such patterns such as, for example, the Weimar Jazz Database (WJD) for jazz. In other genres other pattern repositories 130 can also be used. The pattern repository 130 can contain a large number of common patterns organized according to difficulty level and harmonic context. These can be based on their frequency of occurrence in a stylistically relevant corpus. There can be multiple such repositories (not shown in FIG. 1) which can be accessed depending on which style the student/learner is interested in performing. The repository 130 can also contain professionally performed versions 140 of its most common licks, for reference and for the student to emulate. The pattern repository 130 can contain a high number of common patterns (e.g. ii-V-I patterns 132, ii-V-i patterns 136, V⁷ patterns 134, or other patterns 138). The pattern repository 130 can also contain recorded licks 140, each lick with a rated difficulty level. The determination of the difficulty level of a lick is described in more detail elsewhere in this disclosure.

In an example, to determine difficulty for a jazz lick, WJD melodic sequences, known as n-grams, can be extracted from the WJD. These n-grams can have lengths of 3 to 10 intervals, but other lengths can also be used. Additional information from the database can also be extracted, for instance, manual transcriptions of these melodic sequences and this additional information can be used in the determination of the difficulty level.

For a given set of extracted interval n-grams, a corresponding set of extrinsic and intrinsic difficulty measures or levels can be calculated. Extrinsic difficulty can be based on an entire corpus, whereas intrinsic difficulty can capture features of a pattern per se. One extrinsic difficulty measure comprises the negative logarithm of occurrence probability (i.e., surprisal), as estimated by the relative frequency of an n-gram based on all n-grams of the same length in the corpus. Alternatively, intrinsic difficulty measures can also be used which do not reference other works. The difficulty level or difficulty measure assigned to a lick can comprise extrinsic difficulty, intrinsic difficulty, or some combination of both extrinsic and intrinsic difficulty. The difficulty level assigned to a lick can also comprise a sub-set of the measures for the difficulty level described herein.

On average, larger intervals are harder to play and to perceive and this observation should be reflected in the intrinsic difficulty level. For an n-gram interval I with elements {i₁, i₂, . . . , iₙ} increased intrinsic difficulty can be calculated by either the mean or the maximum of absolute interval values in chromatic steps, which yields two difficulty measures: max abs int(I)=maxₖ|iₖ| and mean_abs_int(I)=(Σₖ|iₖ|)/N. The range of possible values is only bounded by the maximal possible absolute interval values (e.g., 127 for the MIDI pitch representation used in the WJD). These calculations can be adjusted depending on target instrument. For example, if the algorithm is set to “violin,” the interval distance value will be changed to diatonic distance because chromatics are much more difficult to play on violin than on most wind instruments.

A sequence can be considered more complex when it has a larger variety of intervals and a larger variety of corresponding pitches. This variety can be operationalized by the mean number of different intervals (int_variety) or pitches (pitch_variety). int_variety(I)=#{I}/n, where {I} is the set of different elements in I, and the number operator #returns the number of elements in a set.

$$pitch\_variety ( I ) = \frac{\# \{ SI \}}{n + 1} ,$$

where SI are cumulative sums of I, SIₖ=Σ_{0≤j≤k}iₖ, with i₀=0, which has n+1 elements. Both features have a value range between 0 and 1.

An n-gram pattern should be more complex when it often changes directions from ascending to descending or vice versa. This melodic motion or melodic direction can be calculated as the mean number of directions changes (dir_change) or mean length of runs of an interval direction (mean_run_length). dir_change is simply the number of direction changes in a pattern, where a direction change can be measured by using the sign of the difference of interval signs:

$$dir\_change ( I ) = {\sum }_{\vert 1 \leq k < n \vert} \vert sgn ( sgn ( {i}_{k + 1} ) - sgn ( {i}_{k} ) ) \vert$$

For example, the interval pattern [2, 0, 2, 1, −1] has interval directions [1, 0, 1, 1, −1], so there is a change from ascending motion to repetition, followed by an ascending motion of two intervals, and another direction change to descending motion, yielding a total of three direction changes. Using the above formula, {|sgn(0−1)|, |sgn(1−0)|, |sgn(1−1)|, |sgn(−1−1)|}={|−1|,|1|,|0|,|−1|}={1, 1, 0, 1} where the number of direction changes is just the sum (i.e., 3). mean_run_length captures the stretches of movement in the same direction, which can be achieved by using the mean length of runs of an interval direction, where a run is defined as a subsequence of identical elements. Formally, this can be defined as the unique subset of ordered indices j₁, j₂, . . . , jₘ with 1≤jₖ≤n for an n-gram I, such that the interval direction between these indices is constant. The index differences rₖ=jₖ₊₁−jₖ−1 (1≤k<m) are called ‘run lengths’; from this, the mean run length can be defined as

$$mean\_run \_length ( I ) = ( \frac{1}{m} ) {\sum }_{k} {r}_{k} .$$

This value is furthermore normalized to give values between 0 and 1 by dividing it by the maximal possible run length, which is n; finally, this can be subtracted from 1 to achieve the same polarity as the other intrinsic difficulty measures. Hence, mean_run_length(I)=1−mean_run_length(I) n.

Another alternative difficulty measure is the range of intervals int_range=max_run_length(I)−min_run_length(I).

These intrinsic difficulty measures describe different aspects of complexity. A combined measure for intrinsic difficulty can be calculated based on the above items. First, difficulty measures for all extracted n-grams can be calculated. Next, these difficulty measures can be z-transformed for each n-gram length separately (N-scaling) to calculate the combined sum for each n-gram instance. However, int_range and max_abs_int can be excluded because they have a very broad distribution, due to occasional large intervals, and thus might otherwise numerically dominate the other measures. Finally, the sum of N-scaled variables can again be N-scaled to ensure a standard deviation of 1 for ease of interpreting and comparing the numerical values.

### Correlations Among Intrinsic Easiness/Difficulty Measures.

The Pearson's correlations were examined between the different easiness measures for each sequence length from 3 to 10. Due to the large sample size, all correlations can be highly significant (p<0.001), so p-values are not given unless necessary. Large correlations between mean int size and int-range were expected and observed. The correlations range from r=0.91 for shorter sequences (N=3) to r=0.75 for longer sequences (N=10). Similarly, strong correlations between dir_change and mean_run_length were expected. These correlations are even higher, from r=0.95 for N=3 to r=0.81 for N=10. This justified the removal of one measure for each of these pairs. The parameters int_range and dir_change were retained because these have a larger variance and are somewhat easier to interpret.

A large negative correlation was found between pitch_variety and dir_change (between r=−0.50 for N=7 and r=−0.46 for N=3). This is likely because direction changes tend to lead back to a pitch that has previously occurred, particularly for sequences that predominantly consist of semitones and whole tones. Since this correlation is a meaningful result, and not due to construction, both variables were retained. There are also moderately positive correlations between int_variety and int_range (between r=0.38 for N=3 and r=0.40 for N=5), which is even larger for int_variety and mean_int_size. Notably, the correlations in the simulated corpus show similar values, so this effect seems to be a consequence of the relative rarity of large intervals. Similarly, dir_change and int_variety are also moderately correlated (between r=0.23 for N=3 and r=0.41 for N=10). This is due to the fact that a direction change implies a change of sign of subsequent intervals, which increases interval variety. As can be expected from their construction, int_variety and pitch_variety are uncorrelated (between r=0.00 for N=3 and r=0.12 for N=10).

### Correlations Between Extrinsic and Intrinsic Easiness.

Extrinsic easiness was found to be correlated positively with all measures of intrinsic easiness: int_variety (r=0.50), int_range (r=0.43), dir_change (r=0.23), and pitch_variety (r=0.15) (averaged across all N's). Simulated data revealed similar but consistently lower correlations (int_variety r=0.37, int_range r=0.37, pitch_variety r=0.03) with the exception of direction change (dir_change r−0.26).

### Polynomial Analysis.

Easiness trends were tested for possible better description by polynomials and, if so, to what degree. For a set of maximum phrase positions (10, 20, . . . , 50), a set of polynomial regressions of intrinsic easiness against phrase positions for degree 1 to 5 were computed. Analyses were computed for each N separately, and for all data (“full”) and mean values per phrase position (“averaged”). Model performance was then assessed by the Aikake Information Criterion (AIC) and noted all model improvements from degree k to degree k+1, if the decrease in AIC was larger than −10 or if it was the maximum overall decrease. If more than one candidate was found, the one with the largest R²_{adj} value was chosen. No linear models were chosen as the optimal model. Thus, an overall tendency was found for higher polynomial degrees for longer phrases. A bootstrap test using the poweRLaw package for R did not reject the null-hypothesis of a non-power law distribution (p=0.48), with a scaling parameter of 1.28.

### Computer Systems

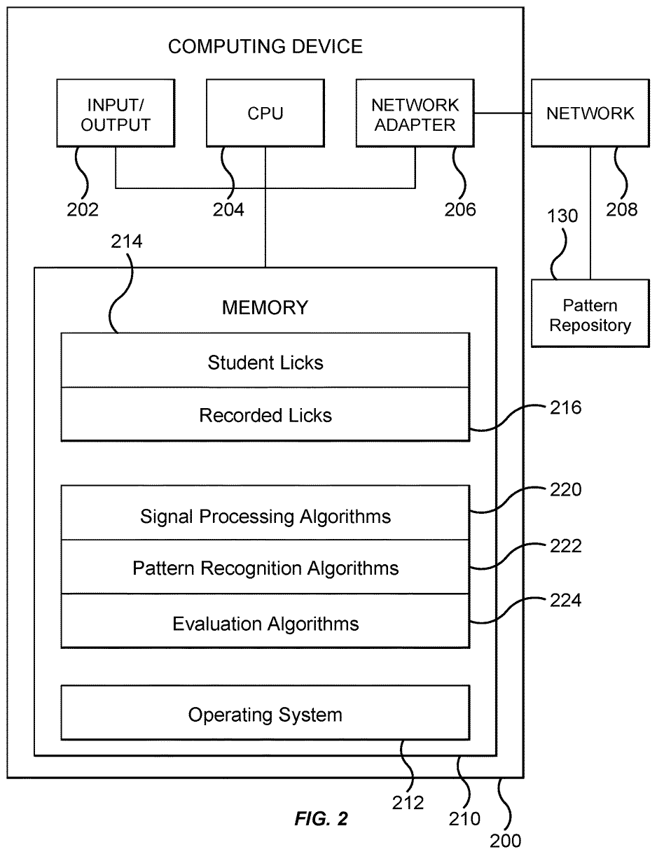

Aspect and embodiments of the systems and methods described herein can include the use of a computing device 200, as shown in FIG. 2. Such a computing device 200 can have input and output 202 devices attached, adjacent, or connected to it. In an example, such input/output devices can comprise speakers for producing sound and a microphone for recording sound. Further input devices comprise, but are not limited to, a computer mouse, a keyboard, a trackball, direct connection of a musical instrument to the computing device 200, and the like. Further output devices include, but are not limited to, speakers, projectors, displays, and the like. The computing device 200 can also comprise a central processing unit 204, also called a CPU. The computing device 200 can have memory and storage 210 wherein can be stored student licks 214 or licks recorded by other musicians 216. The memory 210 of the computing device 200 can also have an operating system 212, such as Linux, UNIX®, OS/2®, Windows®, macOS®, and the like. The computing device can have a network adapter 206, which can be a wired connection or a connection maintained through the use of radio-frequency transmission and reception, or through other methods (e.g. fiber-optic communications). Through the network adapter 206, the computing device can connect to an outside network 208, which permits access to the pattern repository 130.

Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. Thus, it is impossible for any program to damage the execution of any of the other programs running on the system. However, the programs have no way to exchange any information except through the operating system (or by reading files stored on the file system).

Multi-process computing is similar to multi-tasking computing, as the terms task and process are often used interchangeably, although some operating systems make a distinction between the two. The present invention can be a system, a method, and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire. Computer readable program instructions described herein can be downloaded to respective computing/processing devices from a computer readable storage medium or to an external computer or external storage device via a network 208, for example, the Internet, a local area network, a wide area network and/or a wireless network. The network 208 can comprise copper transmission cables, optical transmission fibers, wireless transmission, routers, firewalls, switches, gateway computers, and/or edge servers. A network adapter card 206 or network interface 206 in each computing/processing device 200 receives computer readable program instructions from the network 208 and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network 208, including a local area network (LAN) or a wide area network (WAN), or the connection can be made to an external computer (for example, through the Internet using an Internet Service Provider).

In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s).

In some alternative implementations, the functions noted in the blocks can occur out of the order noted in the Figures. For example, two blocks shown in succession may, in fact, be executed substantially concurrently, or in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or that carry out combinations of special purpose hardware and computer instructions. Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

From the above description, it can be seen that the present invention provides a system, computer program product, and method for the efficient execution of the described techniques. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims.

While the foregoing written description of the invention enables one of ordinary skill to make and use what is considered presently to be the best mode thereof, those of ordinary skill will understand and appreciate the existence of alternatives, adaptations, variations, combinations, and equivalents of the specific embodiment, method, and examples herein. Those skilled in the art will appreciate that the within disclosures are exemplary only and that various modifications can be made within the scope of the present invention. In addition, while a particular feature of the teachings may have been disclosed with respect to only one of several implementations, such a feature can be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

Other embodiments of the teachings will be apparent to those skilled in the art from consideration of the specification and practice of the teachings disclosed herein. The invention should therefore not be limited by the described embodiment, method, and examples, but by all embodiments and methods within the scope and spirit of the invention. Accordingly, the present invention is not limited to the specific embodiments as illustrated herein, but is only limited by the following claims.

What is claimed is:

1. A method of teaching a user to improve improvisational musical skills comprising:
detecting, at an audio detecting device, a user-played lick and converting the user-played lick to an electrical signal;
matching, at a pattern recognition module, the user-played lick to a lick selected from a pattern repository comprising a database of licks;
calculating a metric associated with how well the user-played lick matches the selected lick; and
conveying the metric to the user.

2. The method of claim 1, further comprising playing, at an audio generating device, the lick selected from the pattern repository, wherein the selected lick is chosen based on an assigned difficulty level and on the metric.

3. The method of claim 2, wherein when the metric is less than or equal to a threshold value then selecting a new lick with a difficulty level equal to or less than a difficulty level of the previously selected lick.

4. The method of claim 2, wherein when the metric exceeds a threshold value then the newly selected lick has a difficulty level greater than or equal to the difficulty level of the previously selected lick.

5. The method of claim 4, wherein when the user has repeatedly played a lick up to a number of times and the metric for each repetition is above the threshold value, then the new selected lick has a difficulty level greater than the difficulty level associated with the previously selected lick.

6. The method of claim 2, wherein the difficulty level of the selected lick is associated with a rarity of the selected lick in the pattern repository.

7. The method of claim 6, wherein the rarity of the selected lick in the pattern repository comprises calculating the negative logarithm of an occurrence probability of an n-gram of the selected lick relative to all n-grams of the same length in the pattern repository.

8. The method of claim 2, wherein the difficulty level of a lick comprises at least one of a mean of a plurality of absolute interval values, a maximum of the plurality of absolute interval values, a range of the plurality of interval values, a mean number of different intervals, a mean number of different pitches, a mean number of direction changes or a mean length of runs in an interval direction.

9. The method of claim 8, wherein the difficulty level further comprises a combined sum of a z-transform of each of the mean of the plurality of absolute interval values, the mean number of different intervals, the mean number of different pitches, the mean number of direction changes and the mean length of runs in an interval direction.

10. The method of claim 1, further comprising prompting the user to play a lick.

11. A system comprising:
an audio detecting device for receiving a user-played lick and converting the played lick to an electrical signal;
a pattern repository comprising a database of licks; and
a computer including non-transitory storage, memory, and a processor coupled together to perform a method comprising:
matching, at a pattern recognition module, the user-played lick to a lick selected from the pattern repository;
calculating a metric associated with how well the user-played lick matches the selected lick; and
conveying the metric to the user.

12. The system of claim 11, further comprising an audio generating device for playing a lick selected from the pattern repository, wherein the selected lick is chosen based on an assigned difficulty level and on the metric.

13. The system of claim 12, wherein the computer further performs the step of: when the metric is less than or equal to a threshold value then selecting a new lick with a difficulty level equal to or less than a difficulty level of the previously selected lick.

14. The system of claim 12, wherein, when the metric exceeds a threshold value then the newly selected lick has a difficulty level greater than the difficulty level of the previously selected lick.

15. The system of claim 14, wherein when the user has repeatedly played a lick up to a number of times and the metric for each repetition is above the threshold value, then the new selected lick has a difficulty level greater than the difficulty level associated with the previously selected lick.

16. The system of claim 12, wherein the difficulty level of the selected lick is associated with a rarity of the selected lick in the pattern repository.

17. The system of claim 16, wherein the rarity of the selected lick in the pattern repository comprises calculating the negative logarithm of an occurrence probability of an n-gram of the selected lick relative to all n-grams of the same length in the pattern repository.

18. The system of claim 12, wherein the difficulty level of a lick comprises at least one of a mean of a plurality of absolute interval values, a maximum of the plurality of absolute interval values, a range of the plurality of interval values, a mean number of different intervals, a mean number of different pitches, a mean number of direction changes or a mean length of runs in an interval direction.

19. The system of claim 18, wherein the difficulty level further comprises a combined sum of a z-transform of each of the mean of the plurality of absolute interval values, the mean number of different intervals, the mean number of different pitches, the mean number of direction changes and the mean length of runs in an interval direction.

20. The system of claim 11, further comprising prompting the user to play a lick.
